(19) United States
(12) Patent Application Publication
(10) Pub. No.: US 2026/0307940 A1
(43) Pub. Date: Oct. 8, 2026

(54) A METHOD FOR ERROR DETECTION ON AN IMAGE SENSOR AND AN ABSOLUTE POSITION MEASURING SYSTEM FOR A PASSENGER TRANSPORTATION SYSTEM

(71) Applicant: INVENTIO AG, Hergiswil (CH)

(72) Inventors: Eric Birrer, Buchrain (CH); Michail Chatzimichailidis, Adliswil (CH)

(21) Appl. No.: 19/483,378

(22) PCT Filed: May 23, 2024
(86) PCT No.: PCT/EP2024/064169

§ 371 Date: Nov. 11, 2025

(30) Foreign Application Priority Data
May 25, 2023 (EP) 23175235.3

(51) Int. Cl. B66B 5/00; B66B 1/34; G01D 5/347; G06K 7/14

(52) U.S. Cl. CPC B66B 5/0018; B66B 1/3492; G01D 5/34776; G06K 7/1413

(57) ABSTRACT

This disclosure provides an absolute position measuring system for a passenger transportation system, in particular for an elevator system, having a code of dark areas and light areas, a light source being configured for illuminating the code, and an image sensor for scanning the code, wherein the absolute position measuring system is configured for detecting errors by illuminating the code by the light source providing a first light intensity, acquiring, via the image sensor, a first measurement value by scanning the code, modifying the light source to provide the second light intensity, acquiring, via the image sensor, a second measurement value by scanning the code, and evaluating a consistency condition using the first measurement value and/or the second measurement value, in particular using the first measurement value and the second measurement value.

### FIELD

This disclosure relates to a method for error detection on an image sensor for an absolute position measuring system of a passenger transportation system, to an absolute position measuring system for a passenger transportation system and to such a passenger transportation system.

### BACKGROUND

An absolute position measuring system may be used to determine an absolute position for a passenger transportation system, in particular for an elevator system. For example, an absolute position of an elevator car can be determined using the absolute position measuring system. The absolute position of the elevator car may be the absolute position within an elevator shaft of the elevator system such that, e.g., the elevator car can be controlled to stop at a predetermined level, for example such that an elevator floor is at an aligned position with respect to the floor of the predetermined level.

Usually, a coded magnetic tape is, e.g., arranged vertically within the elevator shaft and hall-sensors are arranged at the elevator car to read a magnetic code of the coded magnetic tape to determine the absolute position of the elevator car. For example, the document WO 03/011733 A1 relates to such a magnetic absolute position measuring system.

It is further known to replace the magnetic code by an optical code and the hall-sensors by image sensors to reduce costs.

The absolute position measuring system may be a safety critical component of the passenger transportation system since the absolute position measuring system includes safety functions. For example, a speed of the elevator car may be determined and monitored. It is therefore desirable for the sensor to be reliable and accurate. It is also desirable to be informed in case the reliability or accuracy of the sensor may be compromised.

The document WO 2019/011828 A1 relates to a method for configuring security related configuration parameters in a passenger transport installation. The absolute position measuring system may have a redundancy of sensors in order to increase safety. However, providing more than one sensor may increase the costs.

### SUMMARY

Aspects and advantages of the disclosure will be set forth in part in the following description, or may be obvious from the description, or may be learned through practice of the disclosure.

The present disclosure provides a method for error detection on an image sensor for an absolute position measuring system of a passenger transportation system, in particular of an elevator system, an absolute position measuring system for a passenger transportation system, in particular for an elevator system, and a passenger transportation system, in particular an elevator system, having such an absolute position measuring system to enable the use of a single image sensor and to reduce costs.

In one aspect, the disclosure provides a method for error detection on an image sensor for an absolute position measuring system of a passenger transportation system, in particular of an elevator system, using a light source. The method includes the steps of illuminating a code of dark areas and light areas by the light source providing a first light intensity, acquiring, via the image sensor, a first measurement value by scanning the code, modifying the light source to provide a second light intensity, acquiring, via the image sensor, a second measurement value by scanning the code, and evaluating a consistency condition using the second measurement value, in particular using the first measurement value and the second measurement value.

In yet another aspect, the disclosure provides an absolute position measuring system for a passenger transportation system, in particular for an elevator system. The absolute position measuring system includes a code of dark areas and light areas, a light source being configured for illuminating the code and an image sensor for scanning the code. The absolute position measuring system is configured for detecting errors by illuminating the code by the light source providing a first light intensity, acquiring, via the image sensor, a first measurement value by scanning the code, modifying the light source to provide the second light intensity, acquiring, via the image sensor, a second measurement value by scanning the code, and evaluating a consistency condition using the second measurement value, in particular using the first measurement value and the second measurement value.

In another aspect, the disclosure provides a passenger transportation system, in particular an elevator system, having such an absolute position measuring system.

The details of one or more aspects of the disclosure are set forth in the accompanying drawings and the description below. Other features, objects, and advantages of the techniques described in this disclosure will be apparent from the description and drawings, and from the claims.

### DESCRIPTION OF DRAWINGS

A full and enabling disclosure of the present disclosure is set forth in the specification, which makes reference to the appended figures, in which:

FIG. 1 is a schematic view of a code having dark areas and light areas and an image sensor according to embodiments.

FIG. 2 is a flow chart of a method for error detection on an image sensor according to embodiments.

FIG. 3A is a schematic illustration of an expected output of a pixel of an image sensor scanning a dark area or a light area at an illumination with a first light intensity and with a second light intensity.

FIG. 3B is a schematic illustration of an expected output of an erroneous pixel of an image sensor scanning a dark area or a light area at an illumination with a first light intensity and with a second light intensity.

### DETAILED DESCRIPTION

This disclosure relates in general to an absolute position measuring system for a passenger transportation system, in particular for an elevator system, which provides safety functions at reduced costs through the use of a light source.

Further, this disclosure relates to a method for error detection on an image sensor for an absolute position measuring system of a passenger transportation system and to a passenger transportation system having the absolute position measuring system.

An absolute position measuring system for a passenger transportation system according to this disclosure uses a light source to illuminate a code of dark areas and light areas with a first light intensity, acquires a first measurement value by scanning the code with an image sensor, modifies the illumination to obtain a second light intensity, acquires a second measurement value by scanning the code and evaluates a consistency condition using at least the second measurement value in order to detect an error. Preferably, the consistency condition is evaluated using at least the first measurement value and the second measurement value.

Typically, a change between the first measurement value and the second measurement value is to be expected since the measurement conditions, i.e. the illumination of the code, are changing. In embodiments, the first measurement value may be used by the absolute position measuring system to determine the absolute position and the second measurement value may be used for evaluating the consistency condition, e.g. by comparing the second measurement value to a threshold, to conduct an error detection or vice versa.

In further embodiments, also the first measurement value is used for evaluating the consistency condition.

Embodiments of this disclosure may particularly be suitable to be used in passenger transportation systems such as elevator systems. In particular, embodiments for this disclosure may be suitable for use in elevator systems for high buildings, e.g. for elevator cars that move at high speeds, such as at speeds of 3 m/s or more, in particular at speeds of 6 m/s or more, preferably at speeds of 9 m/s or more. Embodiments of this disclosure may further be suitable for use in elevator systems moving in a, in particular partially, horizontal direction. However, for ease of description, hereinafter it is referred to passenger transportation systems, in particular elevator systems, more specifically to elevator cars, moving in the vertical direction.

This disclosure describes, in general, a method for error detection on an image sensor for an absolute position measuring system of a passenger transportation system such as an elevator system. As used herein, the term “on an image sensor” may also refer to components being directly and/or indirectly connected to the image sensor, such as processors and/or components receiving and/or processing data from the image sensor. The method may detect common cause failures of the passenger transportation system being related to the image sensor. The image sensor may be a linear image sensor. The image sensor may be a CMOS sensor. Preferably, the image sensor may be configured to communicate measurement values by row and/or by line. In some examples, the image sensor may be an area sensor.

The absolute position measuring system according to this disclosure includes a code of dark areas and light areas (hereinafter “the code”). For example, the code may be a 2D-code, e.g. a QR-code. In embodiments, the code may be 1D-code, e.g. a barcode. Preferably, the dark areas of the barcode may be black bars and the light areas of the barcode may be white bars. One of the dark areas and the light areas might also have the color of a support materiel, such as a tape, carrying the code.

The absolute position measuring system further includes a light source being configured for illuminating the code, and an image sensor for scanning the code. The light source may be a LED light source assembly. In some examples, the light source may be integrated into the image sensor. In embodiments, the light source may be separate from the image sensor. A “light source”, as used herein, may be any light emitting object.

The absolute position measuring system is configured for illuminating the code by the light source providing a first light intensity. As used herein, the term “illuminating the code” refers to a code portion being illuminated, the code portion being substantially the code that is or will imminently be scanned by the image sensor in order to acquire a first measurement value.

The light source is modified to provide a second light intensity being different to the first light intensity. As used herein, the term “modifying the light source” refers to any modification resulting in a different illumination of the tape, which also may be no illumination. Such modifications may include inter alia turning off a power source of the light source, varying the power delivered to the light source, using an aperture and/or hindering the light source mechanically to illuminate the code.

The absolute position measuring system is configured for acquiring a second measurement value by scanning the code with the image sensor at the second light intensity. The errors are detected by evaluating a consistency condition using the second measurement value, in particular using the first measurement value and the second measurement value.

According to embodiments, the consistency condition may be evaluated by further using a threshold value.

According to embodiments, the consistency condition is a comparison, in particular a comparison of a difference between the second measurement value to the threshold.

Further, errors can also be detected by evaluating a consistency condition using the first measurement value, for example by comparing the first measurement value to a respective threshold.

A “consistency condition”, as used herein, asks for a verification whether the first measurement value and/or the second measurement value and/or any relation between the first measurement value and the second measurement value corresponds to an expected condition. In embodiments, the consistency condition may be verified using the first measurement value, the second measurement value, a third measurement value and/or a fourth measurement value. The third measurement value and/or the fourth measurement value may be acquired at the first light intensity and/or at the second light intensity. The first measurement value and/or the second measurement value may be used by the absolute position measuring system to determine the absolute position of the passenger transportation system, e.g. within an elevator shaft or similar.

The absolute position measuring system is capable of detecting errors such as errors on the image sensor. Errors on the image sensor may include that the image sensor delivers the same value for the first measurement value at the first light intensity and for the second measurement value at the second light intensity. Such an error may be critical for the safety of the passenger transportation system. For example, the absolute position measuring system of an elevator car may be coupled to an emergency brake system that may be activated at, e.g., too high speeds of the elevator car. In case the first measurement value corresponds to the second measurement value, an elevator car control receiving absolute position information from the absolute position measuring system may declare this as a standstill of the elevator car. If an error on the image sensor is present, the elevator car control may declare the received absolute position information as a standstill while the elevator car may in fact be in motion.

In embodiments, a defect of one or more pixels of a plurality of pixels of the image sensor may be detected. For example, a set of first measurement values includes a plurality of measurement values at the first light intensity, one for each of the plurality of pixels and a set of second measurement values includes a plurality of measurement values at the second light intensity, one for each of the plurality of pixels. The consistency condition may for example be verified using at least two of the plurality of measurement values at the first light intensity and at least two of the plurality of measurement values at the second light intensity, preferably using the set of first measurement values and the set of second measurement values.

According to embodiments, the consistency condition may be a comparison, in particular wherein the consistency condition may be a comparison of a difference between the first measurement value and the second measurement value to a threshold. Such embodiments may facilitate the error detection and/or the detection of scanning issues, such as code contamination, image sensor contamination, light source issues or alike.

In embodiments, the threshold may be selected in dependence on the first light intensity and/or the second light intensity. Such embodiments may increase the accuracy in the detection of errors. According to embodiments, the threshold may be selected such that the second measurement value is below the threshold regardless whether a dark area or a light area is scanned in case no error is present.

According to embodiments, the second light intensity may be zero. Such embodiments may save an amount of energy and may serve to increase a lifetime of the light source.

In embodiments, the absolute position measuring system may be configured for executing an error detection within a time period of at most 100 ms, preferably at most 30 ms, particularly preferably at most 10 ms. Such embodiments may increase the safety of the passenger transportation system.

According to embodiments, the light source may be configured to provide a pulsed light. Such embodiments may save an amount of energy and/or may increase the lifetime of the absolute position measuring system and/or of the light source.

Reference now will be made in detail to embodiments of the disclosure, some examples of which are illustrated in the drawings. Each example may be provided by way of explanation of the disclosure, not limitation of the disclosure. For instance, features illustrated or described as part of embodiments may be used with other embodiments to yield still further embodiments. The drawings may not be true-to-scale.

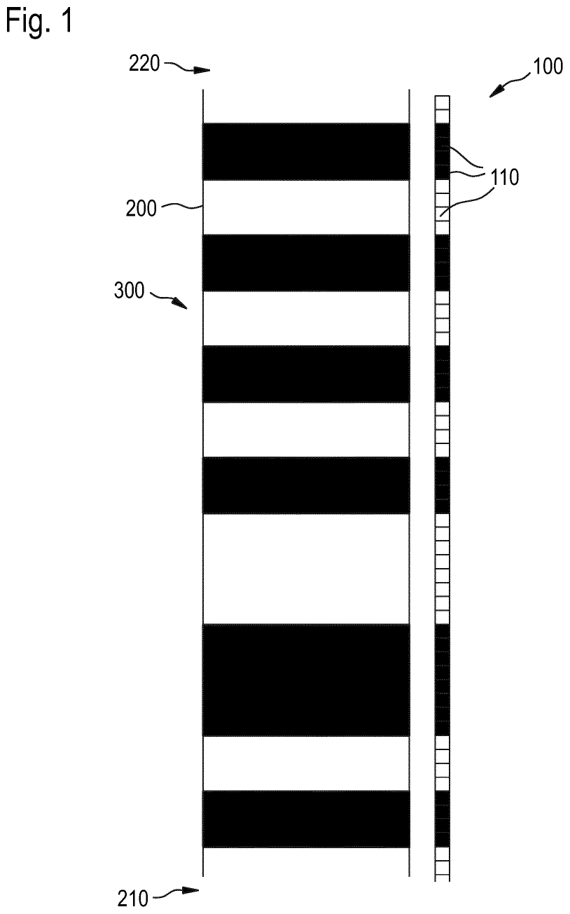

FIG. 1 shows schematically an image sensor 100 and a code of dark areas and light areas, here a barcode 300, on a tape 200 being scanned by the image sensor 100. In FIG. 1, the image sensor 100 is illustrated as being arranged adjacent and parallel to the tape 200. According to FIG. 1, the image sensor 100 is embodied as a linear image sensor having a plurality of pixels 110 being arranged along a height direction in a 1×n scheme. For example, the image sensor 100 may be a CMOS sensor.

The tape 200 may, e.g., be attached to a first vertical end portion 210 of a passenger transportation system and to a second vertical end portion 220 of the passenger transportation system. For example, the passenger transportation system is a vertical elevator system such that the tape 200 is vertically fixed within a shaft of the elevator system. The barcode 300 is printed on the tape 200. Any other technical solution to apply a barcode 300 on the tape could be used as well.

The image sensor 100 is arranged moveably along the tape 200 and is configured for scanning the barcode 300 while being arranged on an elevator car. The image sensor 100 includes an integrated light source for illuminating the barcode 300.

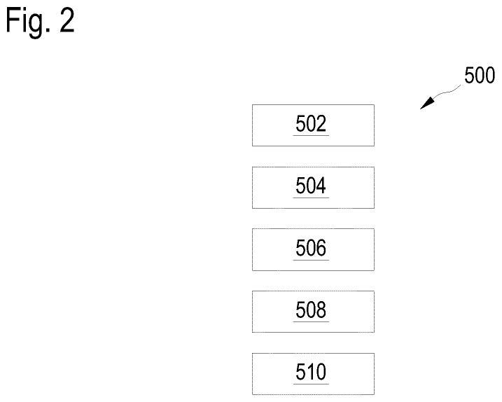

FIG. 2 shows a flow chart of a method 500 for error detection on an image sensor 100 according to embodiments.

The method 500 may be executed by an absolute position measuring system for a passenger transportation system, for example an elevator system. For example, the exemplary absolute position measuring system shown in FIG. 1 may be embodied to execute the method 500 shown in FIG. 2.

The method 500 includes the step of illuminating a code of dark areas and light areas by a light source providing a first light intensity 502. An image sensor 100 acquires a first measurement value by scanning the code 504.

For example, the image sensor 100 may be configured for providing a set of measurement values for a plurality of pixels, preferably for each of a plurality of pixels. In some examples, the measurement value may be any value between a minimum value “0” and a maximum value “100” depending on a measurement object which is measured by a respective pixel. For example, the measurement object may be a white bar which is illuminated by the light source providing the first light intensity. In this case, e.g., it may be expected that the pixel provides a first measurement value of approximately 95.

The method 500 further includes the step of modifying the light source to provide a second light intensity 506 and that the image sensor acquires a second measurement value by scanning the code 508.

For example, the light source provides at this step no light such that the white bar is not illuminated at this step. In this case, e.g., it may be expected that the pixel scanning the non-illuminated white bar provides the second measurement value of approximately 75.

The method 500 further includes the step of evaluating a consistency condition using the first measurement value and/or the second measurement value 510. In embodiments, the method 500 further includes the step of evaluating a consistency condition using the first measurement value and the second measurement value.

For example, the consistency condition may be a comparison between the first measurement value and the second measurement value which is verified in case a predetermined difference between the first measurement value and the second measurement value is present. For example, it may be expected that the first measurement value differs at least by 10 units, one unit being 1% from the maximum value, compared to the second measurement value. The threshold is thus set to 10 units.

The consistency condition may alternatively or additionally verify whether the first measurement value and/or the second measurement value corresponds to an expected value, such as a threshold, for either a, with the first light intensity illuminated, dark area respectively light area or a, with the second light intensity illuminated respectively non-illuminated, dark area respectively light area.

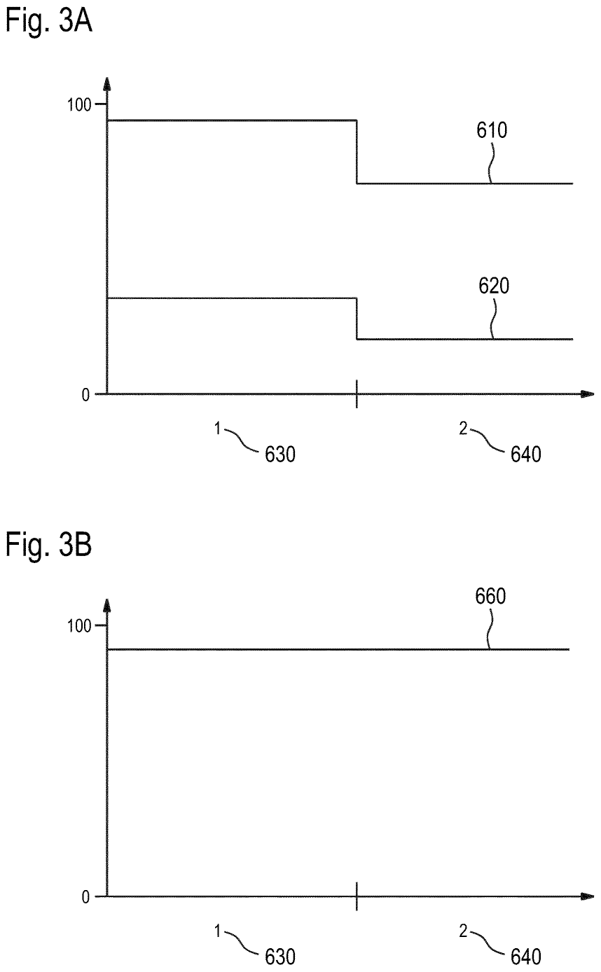

FIG. 3A shows a schematic illustration of an expected output of a pixel of an image sensor scanning a light area 610 and of an expected output of a pixel of the image sensor scanning a dark area 620 at an illumination with a first light intensity 630 and with a second light intensity 640.

The output of the pixel scanning the light area 610 shows a measurement value of approximately 95 of 100 for the scan at an illumination of the light area with the first light intensity 630 that is dropping to approximately 75 of 100 at an illumination of the light area with the second light intensity.

The output of the pixel scanning the dark area 620 shows a measurement value of approximately 35 of 100 for the scan at an illumination of the dark area with the first light intensity 630 that is dropping to approximately 20 of 100 at an illumination of the light area with the second light intensity.

FIG. 3B shows a schematic illustration of an expected output 660 of an erroneous pixel of an image sensor scanning a code of dark areas and light areas at an illumination with a first light intensity 630 and with a second light intensity 640.

As it can be seen from FIG. 3B, although the illumination changes from the first light intensity 630 to the second light intensity 640, no change in the output 660 can be detected. Thus, the respective pixel is most likely defective.

In one or more examples, the functions described may be implemented in hardware, software, firmware, or any combination thereof. If implemented in software, the functions may be stored as one or more instructions or code on a computer-readable medium and executed by a hardware-based processing unit. Computer-readable media may include computer-readable storage media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein.

Thus, an absolute position measuring system, a method for error detection on an image sensor for such an absolute position measuring system and a passenger transportation system with such an absolute position measuring system have been presented in the foregoing description with reference to specific examples. It is to be understood that various aspects disclosed herein may be combined in different combinations than the specific combinations presented in the accompanying drawings. It is appreciated that various modifications to the referenced examples may be made without departing from the scope of the disclosure and the following claims.

1.-19. (canceled)

20. A method for error detection on an image sensor for an absolute position measuring system of a passenger transportation system using a light source, the method comprising steps of:
illuminating a code of dark areas and light areas by the light source providing a first light intensity;
acquiring, via the image sensor, a first measurement value by scanning the illuminated code;
modifying the light source to provide a second light intensity illuminating the code;
acquiring, via the image sensor, a second measurement value by scanning the code illuminated by the second light intensity; and
evaluating a consistency condition using the second measurement value.

21. The method according to claim 20 wherein the step of evaluating the consistency condition includes using a threshold value.

22. The method according to claim 21 wherein the consistency condition is a comparison of the second measurement value to the threshold to detect a difference.

23. The method according to claim 21 wherein the step of evaluating the consistency condition includes using the first measurement value.

24. The method according to claim 23 wherein the consistency condition is a comparison of the first measurement value and the second measurement value to the threshold to detect differences.

25. The method according to claim 21 wherein the threshold is selected in dependence on the first light intensity and/or the second light intensity.

26. The method according to claim 20 wherein the code is a barcode and wherein the dark areas are black bars and the light areas are white bars.

27. The method according to claim 20 wherein the second light intensity is zero.

28. The method according to claim 20 including executing the steps within a time period not exceeding one of 100 ms, 30 ms, and 10 ms.

29. The method according to claim 20 wherein the light source provides a pulsed light.

30. An absolute position measuring system for a passenger transportation system, the system comprising
a code of dark areas and light areas;
a light source illuminating the code;
an image sensor scanning the code; and
wherein the absolute position measuring system detects errors in the image sensor by executing steps of:
illuminating the code with the light source providing a first light intensity;
acquiring, via the image sensor, a first measurement value by scanning the code;
modifying the light source to provide the second light intensity;
acquiring, via the image sensor, a second measurement value by scanning the code; and
evaluating a consistency condition using the second measurement value.

31. The absolute position measuring system according to claim 30 wherein a threshold value is also used for evaluating the consistency condition.

32. The absolute position measuring system according to claim 30 wherein the code is a barcode and wherein the dark areas are black bars and the light areas are white bars.

33. The absolute position measuring system according to claim 30 wherein the consistency condition is a comparison of a difference between the first measurement value and the second measurement value to a threshold.

34. The absolute position measuring system according to claim 33 wherein the threshold is selected in dependence on the first light intensity and/or the second light intensity.

35. The absolute position measuring system according to claim 30 wherein the second light intensity is zero.

36. The absolute position measuring system according to claim 30 wherein the system executes the steps within a time period of not exceeding one of 100 ms, 30 ms, and 10 ms.

37. The absolute position measuring system according to claim 30 wherein the light source provides a pulsed light.

38. A passenger transportation system including the absolute position measuring system according to claim 30.

39. The passenger transportation system according to claim 38 being an elevator system.
